(19) United States
(12) Patent Application Publication
(10) Pub. No.: US 2018/0299976 A1
(43) Pub. Date: Oct. 18, 2018

(54) Digitized writing apparatus

(71) Applicants: Somboon Chiewcharnpipat, Bangkok (TH); Pattana Lee, Chiang Mai (TH)

(72) Inventors: Somboon Chiewcharnpipat, Bangkok (TH); Pattana Lee, Chiang Mai (TH)

(21) Appl. No.: 15/760,933

(22) PCT Filed: Sep. 7, 2015
(86) PCT No.: PCT/TH2015/000057

§ 371 Date: Mar. 16, 2018

(51) Int. Cl. G06F 3/0354; G06F 3/0346; G06F 3/038; G06F 3/041

(52) U.S. Cl. CPC G06F 3/03545; G06F 3/0346; G06F 3/0414; G06F 3/0416; G06F 3/0383

(57) ABSTRACT

A digitized writing apparatus of this invention comprising a portable set of a pen body and a reference medium wherein the pen body and the reference medium each comprising at least a set of pen body position-identifying sensors capable of transmitting and receiving a succession of position-identifying signals between said pen body and reference medium during a writing task. The pen body and the reference medium further comprise at least a set of magnetometer and accelerometer to assist the ultrasonic and infrared systems in identifying the position coordinates, distances, and angles of the pen body in relations to the reference medium. A set of controller and memory units are further introduced to control and coordinate the activation and deactivation of the position-identifying sensors and to record the pen position locations and coordinates during a writing task. A communication module may be optionally installed to enable wireless transmission of a written data to an external device such that the written information can displayed in real-time.

### FIELD OF INVENTION

The invention is related to a digitized writing apparatus and its communication system wherein the digitized writing apparatus comprising a pen body and a reference medium with embedded transducer modules capable of transmitting and receiving pen position-identifying signals during a writing task on a writing surface. The pen body and reference medium further comprising a magnetometer and an accelerometer to assist the transducer modules in identifying or calculating the pen position and pen movement tracking information and forwarding said information to a storage space in a memory unit of the pen body or the reference medium. The writing information, such as a string of characters or graphics, may be sent simultaneously and wirelessly to an external electronic display device or to be stored for later viewing on the external electronic display device.

### BACKGROUND OF THE INVENTION

A conventional digitized writing apparatus (e.g. a digital pen, a wireless pen, or an input pen) generally comprising a pen body and a reference point or a reference medium as two main components that are capable of transmitting and receiving pen position-identifying signals to each other on a writing surface during a writing task by utilizing at least one type of wireless signal, such as acoustic or electromagnetic signal. An ultrasonic sensor or transducer is commonly employed within the digitized writing apparatus wherein the transducer utilizes a triangulation method to identify the pen position by sending off a succession of ultrasonic signals from one ultrasonic transmitter in the pen body to two ultrasonic receivers in the reference medium located on one side or one edge of the writing surface or within a good signaling distance. The two sides of the triangle are equivalent to the distance (d1) from the ultrasonic transmitter to the first ultrasonic receiver and the distance (d2) from the ultrasonic transmitter to the second ultrasonic receiver, and the third side of the triangle is equivalent to the distance (d3) between the two receivers, which are usually fixed as the receivers are laid inside the same reference medium. Once all of the distance values of the three sides have been identified, the apparatus can then calculate the three angles to enable the identification of the pen position and track any changes or movements in the pen position on the writing surface using the triangulation method. The handwritten information, such as a string of characters or graphics, may be transmitted wirelessly to an external device in order to be displayed in real-time or be recorded within the apparatus's own memory unit for later display after the writing task is completed.

The standard triangulation method for pen position detection has also been mentioned in the patent literature, including the invention in the patent U.S. Pat. No. 6,628,270B2 which may be considered as one of the earlier documents to describe a pen type input device that utilized only two ultrasonic receivers to determine the position of input device in multiple input planes. Other more recent patent documents, such as US20040032399A1 and U.S. Pat. No. 7,336,262B2, have also described similar input pen device with an ultrasonic transmitter and a reference medium or distance detection unit with at least two ultrasonic receivers whereby the reference medium is located on the edge or the side of the writing surface, respectively. Both of these documents have mentioned the use of ultrasonic waves to successively transmit position-identifying signals and a distance detector or calculator in the reference medium to compute and input the handwriting locus of characters and graphics written with an input pen into a computer or other external device.

The above examples have, nevertheless, demonstrated some drawbacks since the two ultrasonic signal receivers must be in the pre-determined or fixed locations in relations to the writing surface area. These inventions were simply using the standard triangulation method to identify the pen body or pen tip position in order to minimize the number of sensors used or to allow the apparatus to use only one type of sensor, namely an ultrasonic sensor. Other drawback is related to the writable area (e.g. writable range or signaling range) and the distance between the two receivers which are positively correlated—making some of the reference mediums or detection units considerably elongated or even the same length as the side of the writing surface or paper so that the writable area can also be extended, accordingly. Thus, there has always been a tradeoff between the size of the reference medium and the writable area, which makes it necessary for its user to carry separately a pen body and an elongated reference medium. Due to such characteristics, the conventional apparatus is still not convenient, portable, or suitable for carrying in a shirt pocket as the user would still have to carry the two parts separately.

The digitized writing apparatus of this invention has been designed so that the reference medium is reduced in size, thereby, making it possible to attach onto one end of the pen body or to serve as a part of the pen body. The position-identifying sensors, preferably ultrasonic sensors, are also embedded in the pen body wherein at least one sensor is located near the pen tip and the second sensor is in the opposite end (e.g. top end) of the pen body so that if one sensor is interfered—either by the movement of the pen or the blockage of a hand during writing—one sensor can still effectively transmit or receive signals between the pen body and the reference medium that also comprises at least one ultrasonic sensor. Further, a different type of position-identifying sensors, preferably infrared sensors, can be embedded inside the pen body and the reference medium to assist the ultrasonic system in the transmission or reception of position-identifying signals, as well as to help reduce the amount of energy consumption by the ultrasonic system. The digitized writing apparatus further comprises a pressure sensor to detect the pen tip on writing surface and to activate the position-identifying sensors, and a set of magnetometer and accelerometer to assist the sensor system in detecting and calculating the position coordinates of the pen body during writing task, and a controller and memory unit to control the activation of sensors and the recording of written information in a timely manner, whereby the communication module can be added to transmit said information as a WIFI or bluetooth signal to an external device for a real-time/simultaneous or subsequent display.

### SUMMARY OF THE INVENTION

A digitized writing apparatus as described in the present invention comprising a pen body and a reference medium wherein the pen body and the reference medium each comprising at least a set of transducer module with pen body position-identifying sensors, preferably ultrasonic and infrared sensors, capable of transmitting and receiving a succession of position-identifying ultrasonic and infrared signals between said pen body and reference medium during a writing task. The transducer modules in the pen body and the reference medium further comprising at least one set of magnetometer and accelerometer to assist the ultrasonic and infrared sensors in identifying the position coordinates, distances, and angles of the pen body relative to the plane and the orientation of the writing surface and at least a set of controller and memory unit to control the activation and deactivation of position-identifying sensors and to record the pen position locations and coordinates during a writing task. A communication module may optionally be installed in the pen body and reference medium for real-time or subsequent transmission of written data using any wireless signaling system, preferably a WIFI or Bluetooth system, to an external device.

### BRIEF DESCRIPTION OF THE DRAWINGS

FIG. 1 is showing one configuration of the digitized writing apparatus comprising the pen body and reference medium and the detailed components inside the pen body and reference medium;

FIG. 2 is illustrating one way to utilize the digitized writing apparatus on a writing surface wherein the written information or data can be transmitted via a WIFI or bluetooth system from the pen body or the reference medium to the external device such as computer, lap-top, and smart phone, for simultaneous viewing or subsequent display of written information;

FIG. 3 is the apparatus's triangulation diagram on an X-Y axis showing the reference medium sensor (A), the pen tip sensor (B), and the projection of the other pen sensor onto the writing surface (C), pen tip position coordinates (x, y), and an alpha and beta angles (α, β);

FIG. 4 is the apparatus's triangulation diagram showing the distance from the reference medium sensor to the pen top end sensor (d₂ₘ), the distance between the two pen sensors (P), and the pen tilt theta angle (θ);

FIG. 5 is showing a chi (X) and β angles calculated by the reference made between the pen body and reference medium magnetometers on the X-Y axis;

FIG. 6 is showing X-Z axis that further illustrates the calculation of the theta (θ) and gamma (γ) angles by the pen body accelerometer;

FIG. 7 is illustrating one algorithm of the pen body wherein the pen body comprising at least one ultrasonic receiver;

FIG. 8 is illustrating one algorithm of the reference medium wherein the reference medium comprising at least one ultrasonic transmitter;

FIG. 9 is illustrating one algorithm of the pen body wherein the pen body comprising at least one ultrasonic transmitter; and

FIG. 10 is illustrating one algorithm of the reference medium wherein the reference medium comprising at least one ultrasonic receiver;

### DETAILED DESCRIPTION OF THE INVENTION

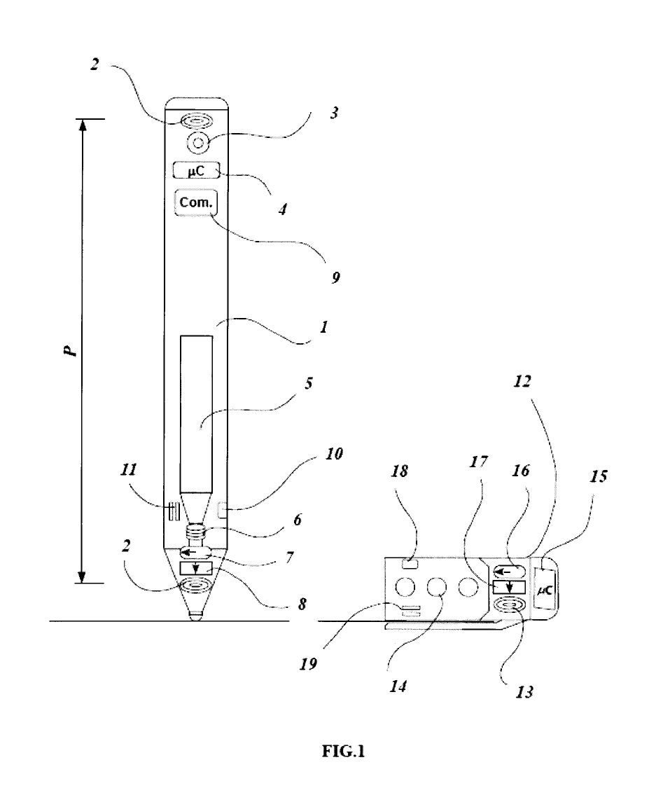

The digitized writing apparatus as illustrated in FIG. 1 generally comprising:

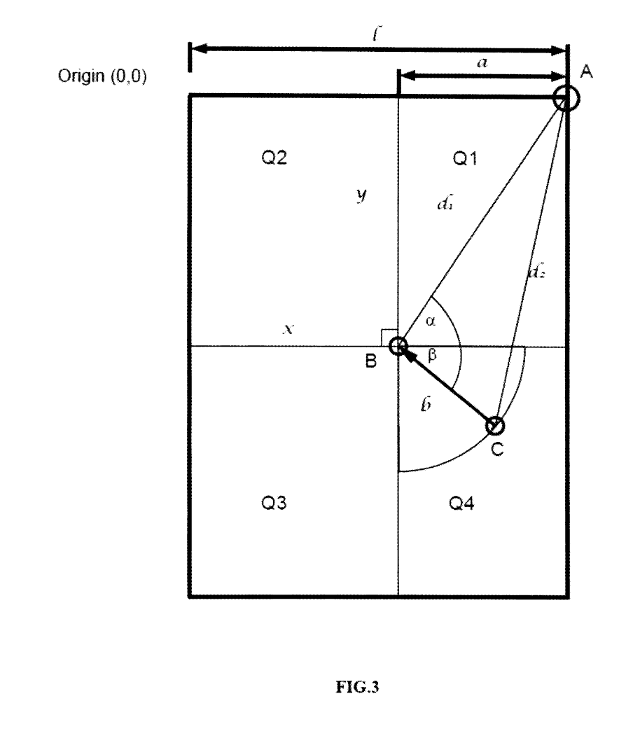

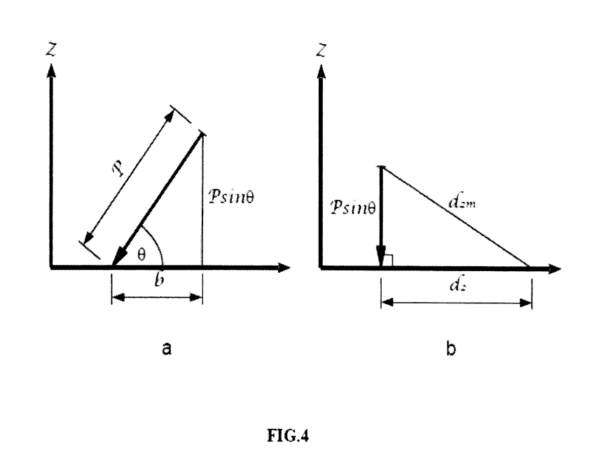

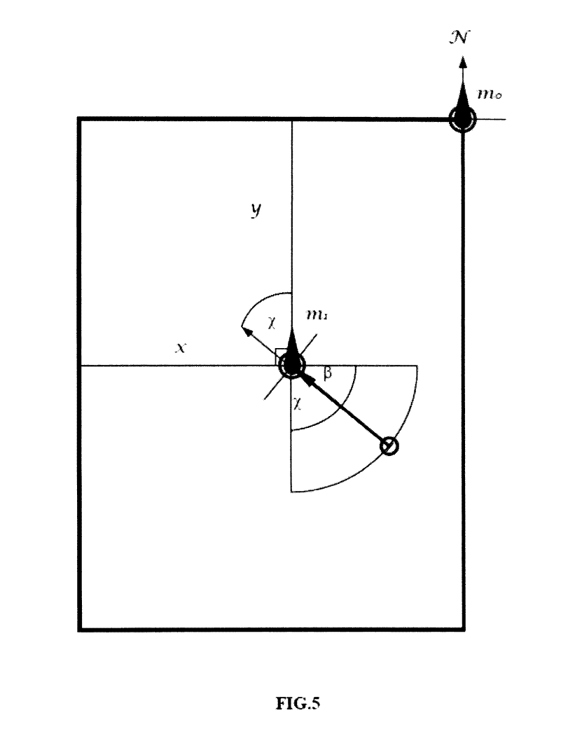

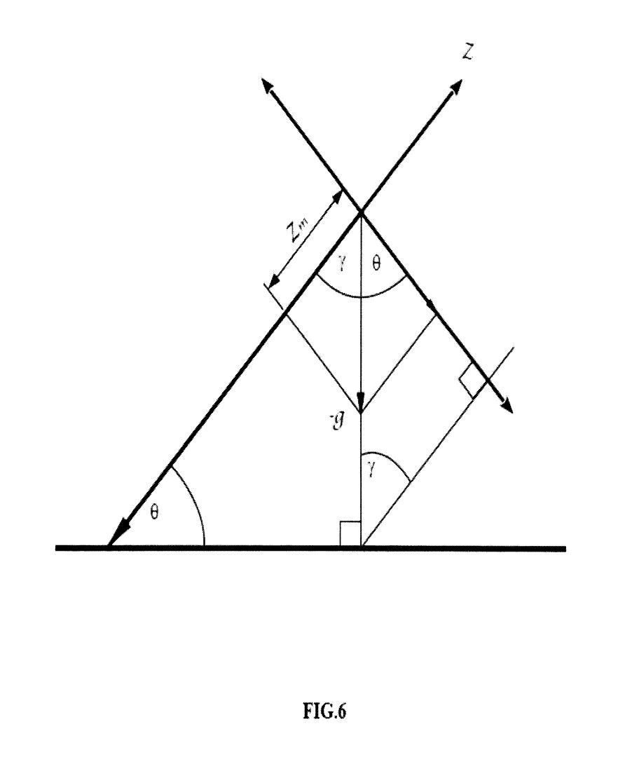

(a) a pen body (1) wherein within the pen body (1) comprising:
a pen ink cartridge (5) connecting to a pen tip for drawing ink onto a writing surface (20) during writing;
a pressure sensor (6) for detecting a pressure of the pen tip on the writing surface (20); and
a pen body transducer module (30) for identifying, tracking, and recording the pen body position based on a triangulation method as illustrated in FIGS. 3-6 wherein said transducer module (30) comprising:
   at least two pen body sensors, preferably ultrasonic (2) and infrared (3) sensors for transmitting the position-identifying signals to or receiving them from a set of reference medium sensors (13, 14) and for identifying a pen body position (including pen tip) on the writing surface (20) by means of calculating a signaling distance 1 (d₁) (i.e. from time of flight of a signal between two sensors) between one ultrasonic sensor near the pen tip (2) and one ultrasonic sensor (13) in the reference medium (12), and a signaling distance 2m (d₂ₘ) between one or more sensors (2, 3) in the top end of the pen body and one or more sensors (13, 14) in the reference medium (12);
   a pen body magnetometer (7 or M1) for identifying, in conjunction with a reference medium magnetometer (16 or M0), the relative orientation of the pen's projection onto the writing surface (to obtain X and β angles) as illustrated in FIG. 5;
   a pen body accelerometer (8) for tracking the pen movement and for identifying the pen tilt angle (θ) as illustrated in FIG.6; and
   a pen body controller and memory unit (4) for carrying out at least one of the following tasks:
      to control the transmission or reception of the position-identifying signals by the pen body sensors (2, 3);
      to control the activation and deactivation of the pen body sensors (2, 3), the pen body magnetometer (7), and the pen body accelerator (8); and
      to record information regarding the pen body position and the movement in pen body position (i.e. distances, angles, and coordinates) received from the pen body sensors (2, 3), the pen body magnetometer (7), and the pen body accelerator (8).
(The distance and angle values calculated by the above sensors (2, 3), magnetometer (7) and accelerometer (8) are continuously recorded by the pen body controller and memory unit (4) and are used for further calculations and recordings of the distance 2 (d₂) as illustrated in FIG. 4, the alpha (α) angle, and x and y coordinates as illustrated in FIG. 3, accordingly)

(b) a reference medium (12), wherein within the reference medium (12) comprising:
a reference medium transducer module (40) to assist the pen body transducer module (30) in identifying, tracking, and recording the pen body position based on a triangulation method as illustrated in FIGS. 3-6 wherein said transducer module (40) comprising:
   at least two reference medium sensors, preferably ultrasonic (13) and infrared (14) sensors for receiving the position-identifying signals from or transmitting them to the pen body sensors (2, 3) and for identifying the pen body position on the writing surface (20) by assisting the pen body sensors (2, 3) in calculating the (d₁) and (d₂ₘ) values;
   a reference medium magnetometer (16 or Mₒ) for assisting the pen body magnetometer (7 or M1) in identifying the relative orientation of the pen's projection onto the writing surface (to obtain X and β angles) as illustrated in FIG. 5; and
   a reference medium controller and memory unit (15) for carrying out at least one of the following tasks:
      to control the transmission or reception of the position-identifying signals by the reference medium sensors (13, 14);
      to control the activation and deactivation of the reference medium sensors (13, 14) and the reference medium magnetometer (16); and
      to record an information regarding the pen body position and the movement in pen body position received from the reference sensors (13, 14) and the reference medium magnetometer (16).
(The distance and angle values calculated by the above sensors (13, 14) and magnetometer (16) are recorded by the reference medium controller and memory unit (15) and are used for further calculations and recordings of the distance 2 (d₂) as illustrated in FIG. 4, as well as the alpha (α) angle, and x and y coordinates as illustrated in FIG. 3, accordingly)

The digitized writing apparatus as described above may further comprise a communication module (9) wherein the communication module (9) is used to transmit the recorded pen body position information wirelessly, preferably a WIFI or bluetooth signal, to an external device (21) such as a computer, a lap-top, a digital tablet, a mobile phone, a smart phone, or other digital display devices with a WIFI or bluetooth receiver.

In the more preferred configuration of the pen body sensors (2, 3) in the pen body transducer module (30), the first ultrasonic sensor (2) is located within close proximity to the pen tip and the second ultrasonic sensor (2) and the infrared sensor (3)—more preferably an infrared diode (3) that can emit infrared signal in all directions—are located within close proximity to an opposite end or top end of the pen body to assist the ultrasonic system in transmitting or receiving signal in the case when one ultrasonic sensor is interfered by hand or movement or other obstruction.

The pen body (1) and reference medium (12) may further comprise a ground electrode (i.e. ground pad) (10, 18) and a data electrode (i.e. data pad) (11, 19) so that, once the writing task is completed, the two parts (1, 12) can be connected or re-connected to enable the data or position information or written information (i.e. same data and sequence) transfer from the reference medium controller and memory unit (15) to the pen body controller and memory unit (4) in the pen body (1).

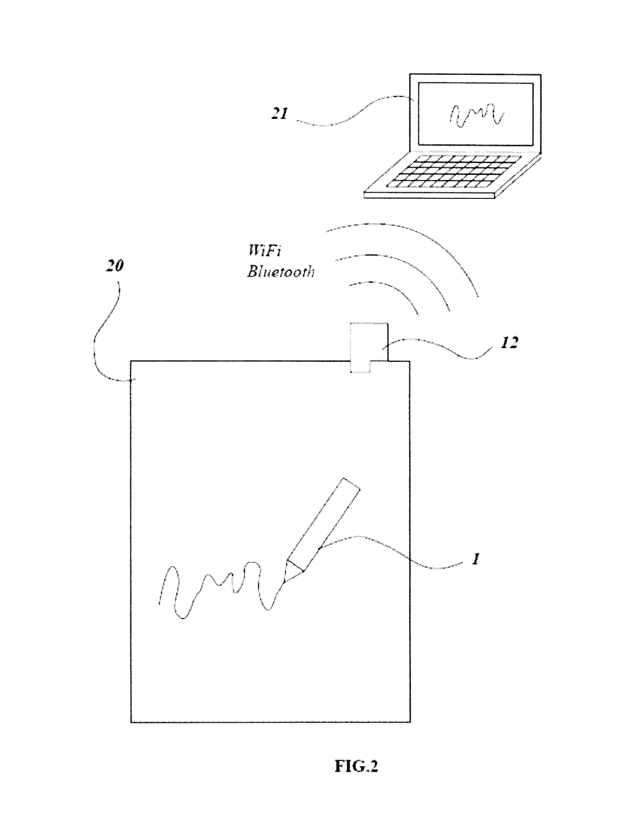

In one embodiment of the apparatus as illustrated in FIG.1 and FIG. 2, the reference medium (12) is in the form of a pen cap wherein the pen cap is attachable to and removable from the pen body (1). The pen cap may further comprise an extended part on the outer surface for fitting, adhering, or clipping on one side or one edge of the writing surface (20) during the writing task. Further, the reference medium may comprise a reference medium accelerometer (17) to assist the pen body accelerometer (8) in tracking the pen movement and in identifying the pen tilt angle (θ) as illustrated in FIG.6, both relative to the writing surface.

A general communication system or algorithm for the digitized writing apparatus according to the above configurations comprising the following steps:
1. placing the pen body (1) and the reference medium (12) separately wherein the pen body (1) is located on the writing surface (20) and the reference medium (12) is located near the edge or the side of the writing surface (20);
2. pushing the pen tip on the writing surface to activate the pressure sensor (6) and the pen body controller and memory unit (4);
3. activating at least one pen body sensor (2, 3) to transmit the position-identifying signal to the reference medium sensor (13, 14);
4. activating the pen body magnetometer (7) and the pen body accelerometer (8) to calculate and track the pen body positions on the writing surface (20);
5. activating the reference medium controller and memory unit (15) in the reference medium (12) for carrying out at least one of the following tasks:
   to forward the signal received by the reference medium sensor (13, 14) from step 3 to the reference medium magnetometer (16) to calculate the pen body position;
   to record or stamp said position information in the reference medium memory unit (15); and
   to activate the reference medium sensor (13, 14) to transmit the position-identifying signal to at least one pen body sensor (2, 3) in the pen body (1);
6. activating the pen body sensor (2, 3) to transmit an internal signal from step 3 or 4 or an external signal from step 5 to the pen body controller and memory unit (4) to successively record the pen body position or change in the pen body position during a writing task; and
7. reiterating the steps 2-6 during the writing task wherein the information can be transmitted wirelessly by the communication module (9) to the external device (21) as illustrated in FIG. 2 or until the writing task is completed wherein the pen body position information in the memory units of the pen body (4) and the reference medium (15) can subsequently be displayed on the external digital device (21) as written information.

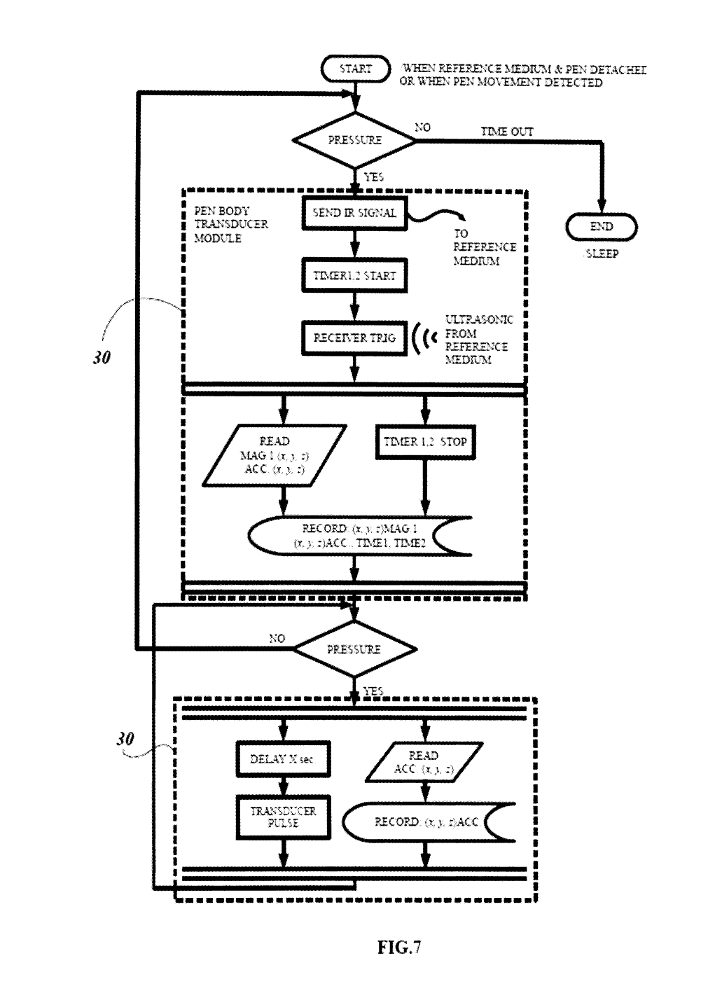

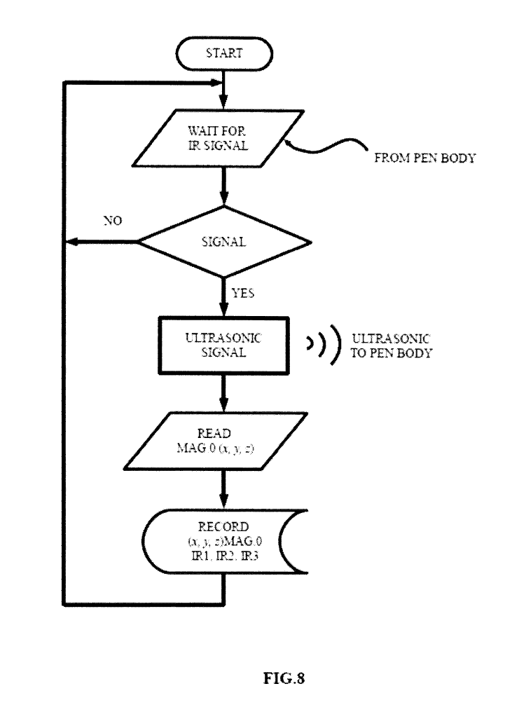

One preferred embodiment of the communication system or algorithm for the digitized writing apparatus, as depicted in FIG. 7 and FIG. 8, comprising the following steps:
1. placing the pen body (1) and the reference medium (12) separately wherein the pen body (1) is located on the writing surface (20) and the reference medium (12) is located near the edge or the side of the writing surface (20);
2. pushing the pen tip on the writing surface to activate the pressure sensor (6) and the pen body controller and memory unit (4);
3. activating at least one pen body infrared transmitter (3) to transmit the position-identifying infrared signal to the reference medium infrared receiver (14);
4. activating the pen body magnetometer (7) and the pen body accelerometer (8) to calculate and track the pen body positions on the writing surface (20);
5. activating the reference medium controller and memory unit (15) in the reference medium (12) for carrying out at least one of the following tasks:
   to forward the signal received by the reference medium infrared receiver (14) from step 3 to the reference medium magnetometer (16) to calculate the pen body position;
   to record said position information in the reference medium memory unit (15); and
   to activate the reference medium ultrasonic transmitter (13) to transmit the position-identifying ultrasonic signal to at least one pen body ultrasonic receiver (2) in the pen body (1);
6. activating the pen body infrared transmitter (3) to transmit an internal signal from step 3 or 4 or an external ultrasonic signal from step 5 to the pen body controller and memory unit (4) to successively record the pen body position or change in the pen body position during a writing task; and
7. reiterating the steps 2-6 during the writing task wherein the information can be transmitted wirelessly by the communication module (9) to the external device (21) as illustrated in FIG. 2 or until the writing task is completed wherein the pen body position information in the memory units of the pen body (4) and the reference medium (15) can subsequently be displayed on the external digital device (21) as written information.

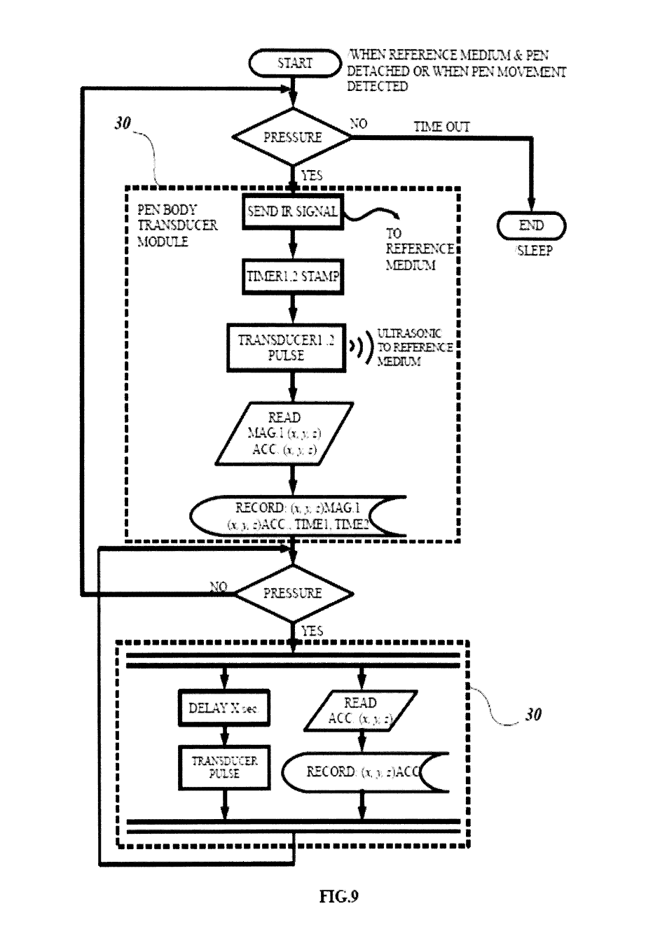

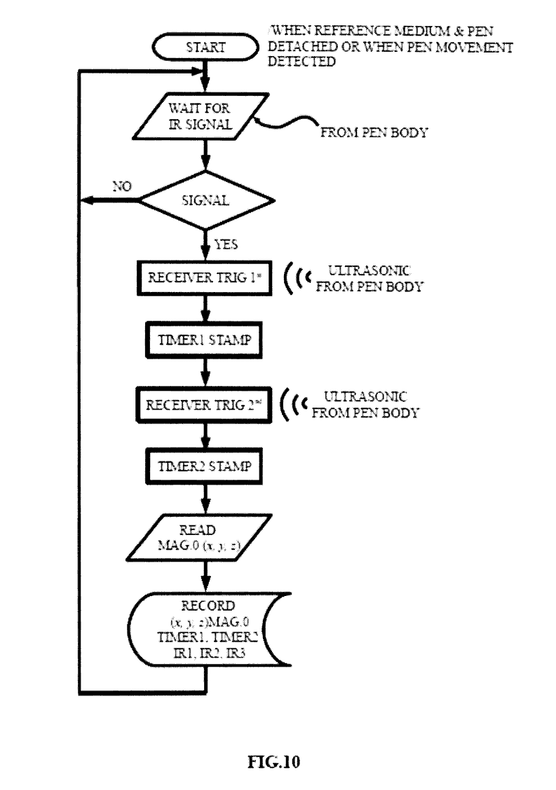

Another preferred embodiment of the communication system or algorithm for the digitized writing apparatus, as depicted in FIG. 9 and FIG. 10, comprising the following steps:
1. placing the pen body (1) and the reference medium (12) separately wherein the pen body (1) is located on the writing surface (20) and the reference medium (12) is located near the edge or the side of the writing surface (20);
2. pushing the pen tip on the writing surface (20) to activate the pressure sensor (6) and the pen body controller and memory unit (4);
3. activating at least one pen body infrared transmitter (3) to transmit the position-identifying infrared signal and at least one pen body ultrasonic transmitter (2) to transmit the position-identifying ultrasonic signal to the reference medium infrared receiver (14) and ultrasonic receiver (13), respectively;
4. activating the pen body magnetometer (7) and the pen body accelerometer (8) to calculate and track the pen body position on the writing surface (20);
5. activating the reference medium controller and memory unit (15) in the reference medium (12) for carrying out at least one of the following tasks:
   to forward the signal received by the reference medium infrared receiver (14) or ultrasonic receiver (13) from step 3 to the reference medium magnetometer (16) to calculate the pen body position; and
   to record said position information in the reference medium memory unit (15);
6. activating the pen body infrared transmitter (3) to transmit an internal signal from step 3 or 4 to the pen body controller and memory unit (4) to successively record the pen body position or change in the pen body position during a writing task; and
7. reiterating the steps 2-6 during the writing task wherein the information can be transmitted wirelessly by the communication module (9) to the external device (21) as illustrated in FIG. 2 or until the writing task is completed wherein the pen body position information in the memory units of the pen body (4) and the reference medium (15) can subsequently be displayed on the external digital device (21) as written information.

1. A digitized writing apparatus comprising:
(a) a pen body, wherein within the pen body comprising:
a pressure sensor for detecting a pressure of a pen tip on a writing surface; and
a pen body transducer module comprising:
at least two pen body sensors for transmitting or receiving pen body position-identifying signals, and for identifying and calculating a pen body position on the writing surface;
a pen body magnetometer for identifying and calculating the pen body position on the writing surface;
a pen body accelerometer for identifying, tracking and calculating the change or movement in pen body position on the writing surface; and
a pen body controller and memory unit for carrying out at least one of the following tasks:
to control the transmission or reception of the position- identifying signal by the pen body sensors;
to control the activation and deactivation of the pen body sensors, the pen body magnetometer, and the pen body accelerator; and
to record an information regarding the pen body position and the movement in pen body position received from the pen body sensors, the pen body magnetometer, and the pen body accelerator.
(b) a reference medium, wherein within the reference medium comprising:
a reference medium transducer module comprising:
at least two reference medium sensors for transmitting or receiving the position-identifying signals, and for identifying and calculating the pen body position on the writing surface;
a reference medium magnetometer for identifying and calculating the pen body position on the writing surface; and
a reference medium controller and memory unit for carrying out at least one of the following tasks:
to control the transmission or reception of the position- identifying signal by the reference medium sensors;
to control the activation and deactivation of the reference medium sensors and the reference medium magnetometer; and
to record an information regarding the pen body position and the movement in pen body position received from the reference medium sensors and the reference medium magnetometer.

2. The digitized writing apparatus of claim 1 wherein the pen body further comprising a pen ink cartridge connecting to the pen tip.

3. The digitized writing apparatus of claim 1 wherein the pen body sensors in the pen body transducer module comprising at least one set of infrared transmitter and ultrasonic receiver.

4. The digitized writing apparatus of claim 1 wherein the pen body sensors in the pen body transducer module comprising at least one set of infrared transmitter and ultrasonic transmitter.

5. The digitized writing apparatus of claim 1 wherein the pen body sensors in the pen body transducer module comprising one infrared transmitter and two ultrasonic receivers.

6. The digitized writing apparatus of claim 1 wherein the pen body sensors in the pen body transducer module comprising one infrared transmitter and two ultrasonic transmitters.

7. The digitized writing apparatus of claim 5, wherein the first ultrasonic receiver or transmitter is located within close proximity to the pen tip and the second ultrasonic receiver or transmitter and the infrared transmitter are located within close proximity to an opposite end or top end of the pen body.

8. The digitized writing apparatus of claim 3, wherein the infrared transmitter is an infrared diode that emits infrared radiation in any or all directions.

9. The digitized writing apparatus of claim 1 wherein the pen body further comprising a communication module for transmitting a wireless information to or from an external device.

10. The digitized writing apparatus of claim 9 wherein the communication module is used to transmit the recorded pen body position information to an external device chosen from a computer, a lap-top, a digital tablet, a mobile phone, a smart phone, or other digital devices.

11. The digitized writing apparatus of claim 1 wherein the reference medium sensors in the reference medium transducer module comprising at least one set of infrared receiver and ultrasonic receiver.

12. The digitized writing apparatus of claim 1 wherein the reference medium sensors in the reference medium transducer module comprising at least one set of infrared receiver and ultrasonic transmitter.

13. The digitized writing apparatus of claim 11, wherein the infrared receiver is an infrared detector array.

14. The digitized writing apparatus of claim 1 wherein the reference medium further comprising a reference medium accelerometer.

15. The digitized writing apparatus of claim 1 wherein within the pen body further comprising a ground electrode and a data electrode.

16. The digitized writing apparatus of claim 1 wherein within the reference medium further comprising a ground electrode and a data electrode.

17. The digitized writing apparatus of claim 1 wherein the reference medium is in a form of a pen cap.

18. The digitized writing apparatus of claim 1, wherein the reference medium is a pen cap that is attachable to and removable from the pen tip or from the opposite end of the pen body.

19. The digitized writing apparatus of claim 17 wherein the pen cap further comprising an extended part on an outer surface for fitting, clipping, or adhering on one side or one edge of the writing surface.

20. (canceled)

21. A communication system for a digitized writing apparatus wherein the digitized writing apparatus comprising:
(a) a pen body, wherein within the pen body comprising:
a pressure sensor for detecting a pressure of the pen tip on a writing surface; and
a pen body transducer module comprising:
at least one pen body infrared transmitter for transmitting a succession of position-identifying infrared signals, and for identifying and calculating a pen body position on the writing surface;
at least one pen body ultrasonic receiver for receiving a succession of position-identifying ultrasonic signal, or for identifying or calculating the pen body position on the writing surface;
a pen body magnetometer for identifying and calculating the pen body position on the writing surface;
a pen body accelerometer for identifying, tracking and calculating the change or movement in pen body position on the writing surface; and
a pen body controller and memory unit for carrying out at least one of the following tasks:
to control the transmission and reception of the position-identifying signals by the pen body infrared transmitter and the ultrasonic receiver;
to control the activation and deactivation of the pen body infrared transmitter and ultrasonic receiver, the pen body magnetometer, and the pen body accelerator; and
to record an information regarding the pen body position and the movement in pen body position received from the pen body infrared transmitter, the pen body ultrasonic receiver, or the pen body magnetometer, and the pen body accelerator.
(b) a reference medium, wherein within the reference medium comprising:
a reference medium transducer module comprising:
at least one reference medium infrared receiver for receiving the position-identifying infrared signal and for identifying and calculating the pen body position on the writing surface;
at least one reference medium ultrasonic transmitter for transmitting the positioning-identifying ultrasonic signal, and for identifying or calculating the pen body position on the writing surface;
a reference medium magnetometer for identifying and calculating the pen body position on the writing surface; and
a reference medium controller and memory unit for carrying out at least one of the following tasks:
to control the transmission and reception of the position-identifying signals by the reference medium infrared receiver and the ultrasonic transmitter;
to control the activation and deactivation of the reference medium infrared receiver and ultrasonic transmitter, or the reference medium magnetometer; and
to record an information regarding the pen body position and the movement in pen body position received from the reference medium infrared receiver, the reference medium ultrasonic transmitter, and the reference medium magnetometer.
wherein the communication system comprising the following steps:
1) placing the pen body and the reference medium separately wherein the pen body is located on the writing surface and the reference medium is located near the edge or the side of the writing surface;
2) pushing the pen tip on the writing surface to activate the pressure sensor and the pen body controller and memory unit;
3) activating at least one pen body infrared transmitter to transmit at the position-identifying infrared signal to the reference medium infrared receiver;
4) activating the pen body magnetometer and the pen body accelerometer to calculate and track the pen body positions on the writing surface;
5) activating the reference medium controller and memory unit in the reference medium for carrying out at least one of the following tasks:
to forward the signal received by the reference medium infrared receiver from step 3 to the reference medium magnetometer to calculate the pen body position;
to record said position information in the reference medium memory unit; and
to activate the reference medium ultrasonic transmitter to transmit the position-identifying ultrasonic signal to at least one pen body ultrasonic receiver in the pen body;
6) activating the pen body infrared transmitter to transmit an internal signal from step 3 or 4 or an external ultrasonic signal from step 5 to the pen body controller and memory unit to successively record the pen body position or change in the pen body position during a writing task; and
7) reiterating the steps 2-6 during the writing task wherein the information can be transmitted wirelessly to an external device or until the writing task is completed wherein the pen body position information in the memory units of the pen body and the reference medium can subsequently be displayed on the external digital device.

22. A communication system for a digitized writing apparatus wherein the digitized writing apparatus comprising:
(a) a pen body, wherein within the pen body comprising:
a pressure sensor for detecting a pressure of the pen tip on a writing surface; and
a pen body transducer module comprising:
at least one pen body infrared transmitter for transmitting a position-identifying infrared signal, and for identifying and calculating a pen body position on the writing surface;
at least one pen body ultrasonic transmitter for transmitting a position-identifying ultrasonic signal, and for identifying or calculating the pen body position on the writing surface;
a pen body magnetometer for identifying and calculating the pen body position on the writing surface;
a pen body accelerometer for identifying, tracking and calculating the change or movement in pen body position on the writing surface; and
a pen body controller and memory unit for carrying out at least one of the following tasks:
to control the transmission of the position-identifying signals by the pen body infrared transmitter and the ultrasonic transmitter;
to control the activation and deactivation of the pen body infrared transmitter and ultrasonic transmitter, the pen body magnetometer, and the pen body accelerator; and
to record the information regarding the pen body position and the movement in pen body position received from the pen body infrared transmitter, the pen body ultrasonic transmitter, the pen body magnetometer, and the pen body accelerator.
(b) a reference medium, wherein within the reference medium comprising:
a reference medium transducer module comprising:
at least one reference medium infrared receiver for receiving the position-identifying infrared signal, and for identifying and calculating the pen body position on the writing surface;
at least one reference medium ultrasonic receiver for receiving the positioning-identifying ultrasonic signal and calculating the pen body position on the writing surface;
a reference medium magnetometer for identifying and calculating the pen body position on the writing surface; and
a reference medium controller and memory unit for carrying out at least one of the following tasks:
to control the reception of the position-identifying signals by the reference medium infrared receiver and the ultrasonic receiver;
to control the activation and deactivation of the reference medium infrared receiver and ultrasonic receiver, and the reference medium magnetometer; and
to record an information regarding the pen body position and the movement in pen body position received from the reference medium infrared receiver, the reference medium ultrasonic receiver, and the reference medium magnetometer.
wherein the communication system comprising the following steps:
1) placing the pen body and the reference medium separately wherein the pen body is located on the writing surface and the reference medium is located near the edge or the side of the writing surface;
2) pushing the pen tip on the writing surface to activate the pressure sensor and the pen body controller and memory unit;
3) activating at least one pen body infrared transmitter to transmit the position-identifying infrared signal and at least one pen body ultrasonic transmitter to transmit the position-identifying ultrasonic signal to the reference medium infrared receiver and ultrasonic receiver, respectively;
4) activating the pen body magnetometer and the pen body accelerometer to calculate and track the pen body position on a writing surface;
5) activating the reference medium controller and memory unit in the reference medium for carrying out at least one of the following tasks:
to forward the signal received by the reference medium infrared receiver or ultrasonic receiver from step 3 to the reference medium magnetometer to calculate the pen body position; and
to record said position information in the reference medium memory unit;
6) activating the pen body infrared transmitter to transmit an internal signal from step 3 or 4 to the pen body controller and memory unit to successively record the pen body position or change in the pen body position during a writing task; and
7) reiterating the steps 2-6 during the writing task wherein the information can be transmitted wirelessly to an external device or until the writing task is completed wherein the pen body position information in the memory units of the pen body and the reference medium can subsequently be displayed on the external digital device.

23. The communication system of claim 21 wherein the pen body further comprising a pen ink cartridge connecting to the pen tip.

24. The communication system of claim 21 wherein the pen body transducer module comprising one infrared transmitter and two ultrasonic receivers.

25. The communication system of claim 21 wherein the pen body transducer module comprising one infrared transmitter and two ultrasonic transmitters.

26. The communication system of claim 21 wherein the first ultrasonic receiver is located within close proximity to the pen tip and the second ultrasonic receiver and the infrared transmitter are located within close proximity to an opposite end of the pen body.

27. The communication system of claim 21 wherein the first ultrasonic transmitter is located within close proximity to the pen tip and the second ultrasonic transmitter and the infrared transmitter are located within close proximity to an opposite end of the pen body.

28. The communication system of claim 21 wherein the pen body further comprising a communication module for transmitting a wireless information to or from an external device.

29. The communication system of claim 28 wherein the communication module is used to transmit the recorded pen body position information to an external device chosen from a computer, a lap-top, a digital tablet, a mobile phone, a smart phone, or other digital devices.

30. The communication system of claim 21 wherein the reference medium further comprising a reference medium accelerometer.

31. The communication system of claim 21 wherein within the pen body further comprising a ground electrode and a data electrode.

32. The communication system of claim 22 wherein within the reference medium further comprising a ground electrode and a data electrode.

33. The communication system of claim 21 wherein the reference medium is in a form of a pen cap.

34. The communication system of claim 33 wherein the pen cap is attachable to and removable from the pen tip or from the opposite end or top end of the pen body.

35. The communication system of claim 23 wherein the pen cap further comprising an extended part on an outer surface for fitting, clipping, or adhering on one side or one edge of the writing surface.
